(19) United States
(12) Patent Application Publication
(10) Pub. No.: US 2003/0053756 A1
(43) Pub. Date: Mar. 20, 2003

(54) Optical coupling mount

(76) Inventors: Yee Loy Lam, Singapore (SG); Peh Wei Tan, Singapore (SG); Yan Zhou, Pleasanton, CA (US)

Correspondence Address: PERMAN & GREEN, 425 POST ROAD, FAIRFIELD, CT, 06824, US

(21) Appl. No.: 10/006,752

(22) Filed: Nov. 8, 2001

(30) Foreign Application Priority Data
Sep. 17, 2001 (GB) 0122425.2

(51) Int. Cl. G02B 6/30; G02B 6/26

(52) U.S. Cl. 385/49; 385/50; 385/52; 385/43

(57) ABSTRACT

An optical coupling mount for use in coupling light between a semiconductor waveguide device and an optical fibre comprises a silica based spot size converter (3) located on an optical bench (1) with a trench (8) and grooves (9), whereby the semiconductor device (2) can be positioned in close alignment with the spot size converter (3). The spot size converter (3) comprises a tapered upper waveguide (4) located above a non-tapered lower waveguide (6). The dimensions of the spot size converter (3) are such that a semiconductor device emitting a small, astigmatic optical beam can be efficiently coupled to a single mode fibre requiring a larger, concentric beam.

### BACKGROUND TO THE INVENTION

There is a great need to couple efficiently the light between a semiconductor edge emitting waveguide device and a single mode optical fibre. In order to achieve significant coupling, it is often necessary to convert the small and severely astigmatic optical mode profile obtained from a semiconductor waveguide device such as a ridge-guided laser, a modulator or a semiconductor optical amplifier, to the concentric and larger modal profile of a single mode fibre. Typically, this modal mismatch results in a coupling loss of between 8 and 10 dB.

Current approaches for achieving such coupling are threefold: (a) employment of a micro-lens system between the device and the fibre, (b) use of a converter fibre, such as a graded refractive index (GRIN) fibre, at the tip of the single mode fibre, and (c) incorporation of a spot size converter with the semiconductor substrate i.e. monolithically integrate the spot size converter and semiconductor laser. The disadvantages of method (a) are those of high cost and complexity of alignment and mounting, of method (b) are those of instability and tight alignment tolerance and of method (c) are the potentially lower device yield resulting from the increased processing difficulties and the added cost of the III-V semiconductor material. In addition, all the above-mentioned approaches suffer from a misalignment problem associated with coupling single mode devices, whereby a 1 dB decrease in coupling efficiency can result for a lateral misalignment of less than +/−0.5 μm.

### SUMMARY OF THE INVENTION

According to one aspect of the present invention, an optical bench for coupling light between an optical device and an optical fibre, the optical bench comprising an integral optical spot size converter and optical alignment means for fixing the position of an initially separate optical device relative to the optical spot size converter so that, in use, light is coupled between the optical device and the optical spot size converter.

In the present invention, we provide an optical bench upon which is located an optical spot size converter and provision for alignment and mounting of a separately formed optical device such that on assembly the spot size converter is in close alignment with the optical device. Accordingly, the present invention provides a simple means for efficient and stable coupling of light between a semiconductor waveguide device and spot size converter that provides for the conversion of a small and astigmatic spot shape to one that is well matched to a single mode fibre. A robust assembly technique is included to assist in the alignment of the waveguide device relative to the spot size converter leading to an overall inexpensive optical package.

Preferably, the optical bench is formed of a silica material.

Preferably, the optical device is a semiconductor edge emitting waveguide device. Examples of such devices include laser diodes, light emitting diodes, array waveguide gratings and semiconductor optical amplifiers.

Preferably, the spot size converter comprises a pair of waveguides, at least one of which is dimensioned so as to cause light preferentially to couple from one waveguide to the other as light propagates along the length of the waveguide. More preferably, the spot size converter comprises an upper waveguide having a reducing lateral taper along at least part of its length, vertically spaced a distance above a non-tapering lower waveguide. Preferably, the upper waveguide and lower waveguide are separated by a cladding region.

In the present invention, light from a semiconductor waveguide device mounted on the optical device enters the spot size converter via the facet of the non-tapering end of the upper waveguide. The dimensions of the upper waveguide at the facet are such that its mode and distribution is well matched to that of the device to be coupled. Similarly, the dimensions and extent of the taper are such that the optical mode propagating in the upper waveguide is efficiently coupled into the lower waveguide.

Light exiting the lower waveguide can be coupled into an optical fibre, preferably a single mode optical fibre. Again, the dimensions of the lower waveguide are selected such that its mode and distribution is well matched to that of the fibre into which the light is to be coupled.

Preferably, the optical alignment means is adapted to receive the optical device. More preferably, the optical alignment means is keyed for engagement with the optical device. Most preferably, the optical alignment means comprises at least one trench in the optical bench within which the optical device is to be located and one or more alignment grooves or ridges that can cooperate with the corresponding alignment ridges or grooves, respectively, formed on the optical device. These forms of alignment ridges or alignment grooves can be created by conventional lithographic and etching techniques, or by using embossing. Additional alignment marks can be added that aid the assembly process.

The output light from the spot size converter can be launched into an optical fibre by a conventional butt-coupling technique. It is preferred that the optical bench includes an integral v-groove dimensioned to allow for the location of an optical fibre adjacent a facet of the spot size converter.

According to another aspect of the present invention, an optical assembly comprises the combination of an optical bench in accordance with the one aspect of the present invention, an optical device located on the optical bench, and an optical fibre, each of the optical device and optical fibre being aligned with the spot size converter to provide coupling of light between the optical device and the optical fibre.

### BRIEF DESCRIPTION OF THE DRAWINGS

Examples of the present invention will now be described in detail with reference to the accompanying drawings, in which:

FIG. 1 is a perspective view of an example of an optical coupling mount in accordance with the present invention;

FIG. 2 is a schematic cross sectional view showing the arrangement of a spot size converter integrated within the optical coupling mount shown in FIG. 1;

FIGS. 3A and 3B are schematic cross sectional views showing the arrangement of an example of a spot size converter at the input and output facets of the spot size converter, respectively;

FIGS. 4A and 4B show the simulated optical field distributions at the input and output facets of the spot size converter shown in FIGS. 3A and 3B;

FIG. 5 shows the calculated variation in coupling loss with vertical misalignment of the input facet of the spot size converter of FIG. 3A;

FIG. 6 shows the calculated variation in coupling loss with lateral misalignment of the input facet of the spot size converter of FIG. 3A;

FIG. 7 shows another example of an optical bench in accordance with the present invention;

FIG. 8 shows a plan view of the optical bench shown in FIG. 7; and,

FIG. 9 shows a plan view of a further example of an optical bench in accordance with the present invention.

### DETAILED DESCRIPTION

As shown in FIG. 1, an optical bench 1, for use with a semiconductor edge emitting waveguide device 2, is provided with an integrated spot size converter 3 including an upper waveguide 4, featuring a reducing lateral taper along part of its length 5,and a non-tapering lower waveguide 6 vertically separated by a cladding region 7.

The waveguide device 2 can be accurately positioned on the optical bench 1 with respect to the spot size converter 3 by means of a trench 8 and a pair of alignment grooves 9 which engage with a pair of alignment ridges 10 on the waveguide device 2.

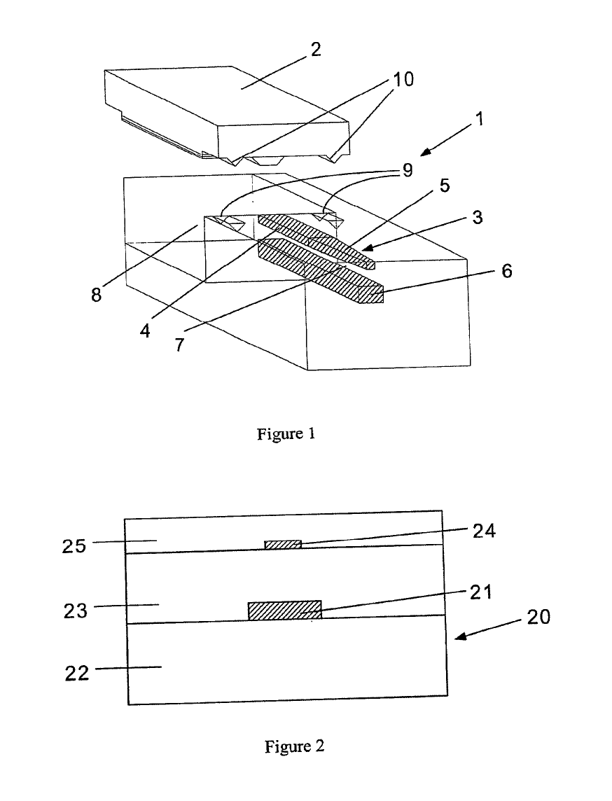

The cross sectional view of FIG. 2 shows an example of the construction of a spot size converter 20. The fabrication process requires four levels of masking: two masks are used for defining the spot size converter 20 and a further two are used for alignment grooves and metal contact access (not shown).

During fabrication a 2 μm thick layer of SiO₂ 21, with a refractive index of 1.475, is deposited and etched on a substrate of grown silica-on-silicon (SOS) 22, with a refractive index of 1.46. This SiO₂ layer, which acts as the lower waveguide for the spot size converter, is fabricated by a plasma-enhanced chemical vapour deposition (PE-CVD) process. A 5 μm thick layer of a sol-gel glass 23, with a refractive index of 1.46 (equal to that of the substrate), is spin-coated across the wafer to surround the lower waveguide 21. A 1 μm thick layer of silicon oxynitride (SiON) 24, with a higher refractive index of 1.56, is deposited and etched on the sol-gel glass 23 to form the upper waveguide of the spot size converter 3. A photolithography process is used to define the tapered structure of the upper waveguide 24. A final layer of a similar sol-gel glass 25, with refractive index of 1.46, is spin-coated across the wafer to surround the upper waveguide 24 and to act as a passivation layer.

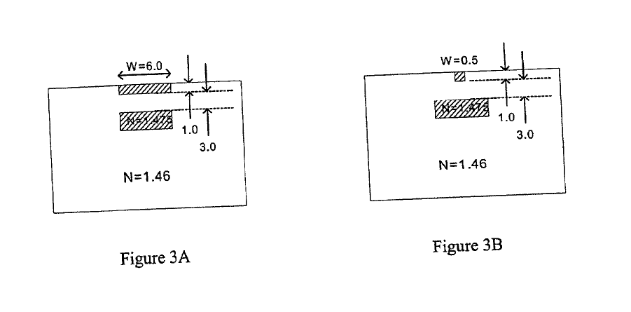

FIGS. 3A and 3B are schematic cross sectional views showing a particular arrangement of the spot size converter of FIG. 2, designed to couple a ridge laser at the input facet and a single mode optical fibre at the output facet of the spot size converter, respectively. As shown, the upper waveguide tapers from 6 μm to 0.5 μm.

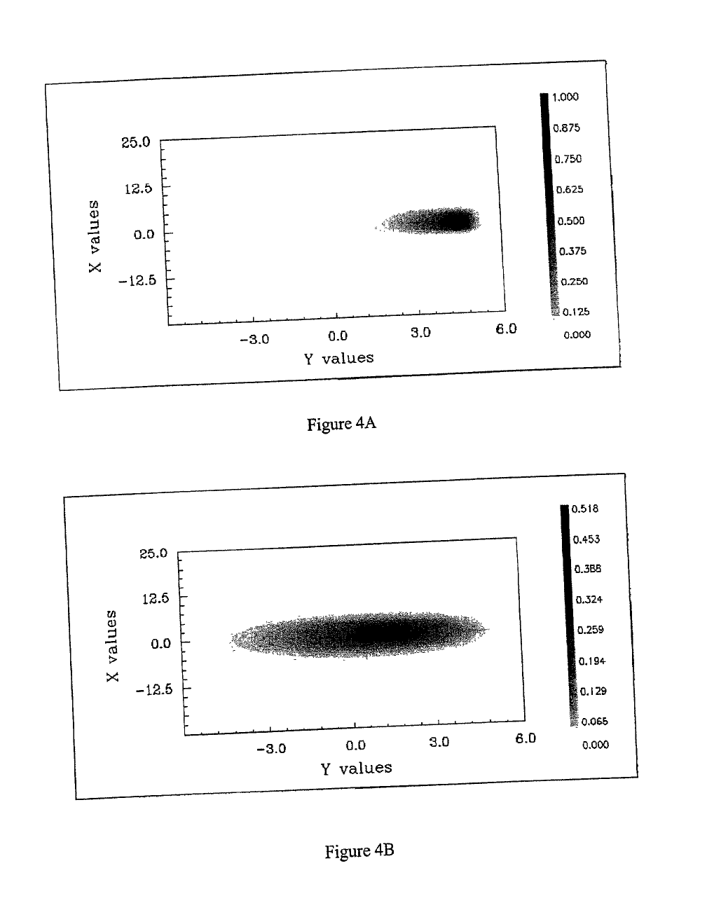

FIGS. 4A and 4B are simulated views of the optical field distributions at the input and output facets of the spot size converter shown in FIGS. 3A and 3B, respectively. A highly confined spot size, which closely matches that of a ridge laser, is injected at the input facet of the spot-size converter with a calculated laser to converter coupling loss of between 1.25 and 1.3 dB. As the injected optical beam propagates through the converter, light couples from the upper to lower waveguide due to the lateral taper of the upper waveguide. The spot-size at the output facet of the converter, for the design simulated, yielded an 88% modal distribution matching with a single mode fibre and with a high mode conversion efficiency of 97%.

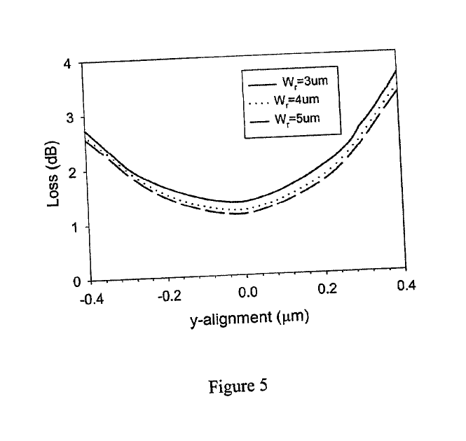

FIG. 5 shows the calculated variation in coupling loss with vertical misalignment at the input facet of the spot size converter for three different sizes of ridge laser. The results illustrate that where ridge lasers of width between 3 and 5 μm are considered, it is determined that a misalignment of 0.3 μm would result in a loss of less than 2 dB.

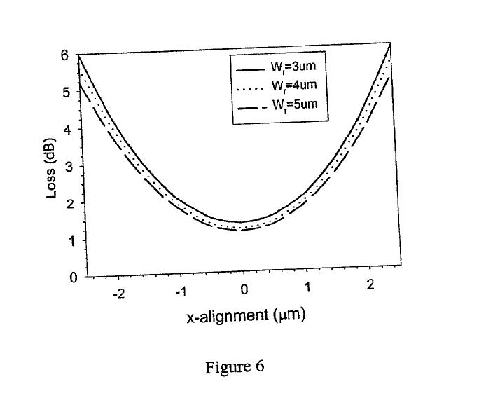

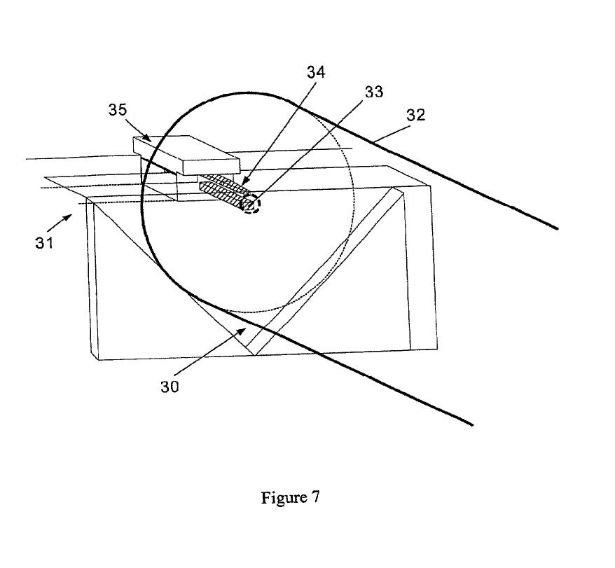

FIG. 6 shows the calculated variation in coupling loss with lateral misalignment at the input facet, for the simulations considered in FIG. 5. Here the results illustrate that a loss of less than 3 dB can be achieved for a misalignment of less than 1.75 μm, which is comparable to other semiconductor monolithically integrated spot-size converters.

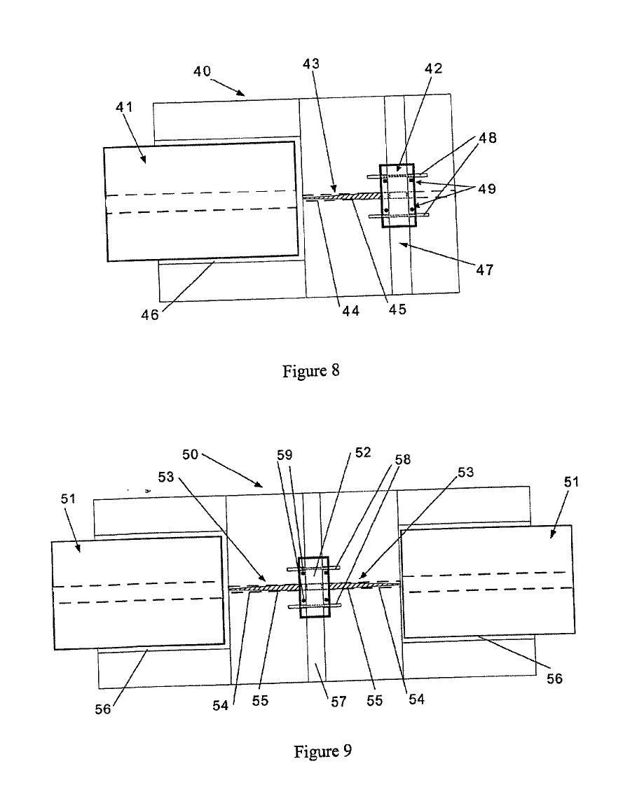

FIG. 7 shows the provision of a v-groove 30 in the optical bench 31 which can aid in the alignment of an optical fibre 32 when, for instance, butt-coupled to the output facet 33 of the spot size converter 34. Also shown is a semiconductor waveguide device (ridge laser) 35 which provides the input light to the spot size converter 34. FIG. 8 is plan view of FIG. 7 and shows the relative positioning, on the optical bench 40, of the optical fibre 41, semiconductor waveguide device 42 and spot size converter 43, including the lower waveguide 44 and upper waveguide 45 of the spot size converter 43. Also shown are the aids to alignment including: the v-groove 46, the trench 47, the alignment grooves 48 and some additional alignment marks 49.

FIG. 9 shows a symmetrical variant of the embodiment illustrated in FIG. 8 to provide for fibre to waveguide device to fibre coupling. Located on the optical bench 50 are the two optical fibres 51, the waveguide device to which they are to be coupled 52, and two spot size converters 53, including the lower waveguides 54 and upper waveguides 55 of the spot size converters 53. Also shown are the aids to alignment including: two v-grooves 56, a trench 57, alignment grooves 58 and some additional alignment marks 59. The embodiment shown in FIG. 9 has many applications where the propagation of light in a fibre has to be interrupted for the purposes of amplification or modulation.

1. An optical bench for coupling light between an optical device and an optical fibre, the optical bench comprising an integral optical spot size converter and optical alignment means for fixing the position of an initially separate optical device relative to the optical spot size converter so that, in use, light is coupled between the optical device and the optical spot size converter.

2. An optical bench according to claim 1, formed of a silicon material.

3. An optical bench according to claim 1 or claim 2, in which the spot size converter comprises a pair of waveguides, at least one of which is dimensioned so as to cause light preferentially to couple from one waveguide to the other as light propagates along the length of the waveguide.

4. An optical bench according to any preceding claim, in which the spot size converter comprises an upper waveguide having a reducing lateral taper along at least part of its length, vertically spaced a distance above a non-tapering lower waveguide.

5. An optical bench according to claim 4, in which the upper waveguide and lower waveguide are separated by a cladding region.

6. An optical bench according to any preceding claim, in which the optical alignment means is adapted to receive the optical device.

7. An optical bench according to any preceding claim, in which the optical alignment means is keyed for engagement with the optical device.

8. An optical bench according to any preceding claim, in which the optical alignment means comprises at least one trench in the optical bench within which the optical device is to be located and one or more alignment grooves or ridges that cooperate with corresponding alignment ridges or grooves, respectively, formed on the optical device.

9. An optical bench according to any preceding claim, further comprising an integral V-groove dimensioned to allow for the location of an optical fibre adjacent a facet of the spot size converter.

10. An optical assembly comprising an optical bench according to any preceding claim in combination with an optical device located on the optical bench, and an optical fibre, each of the optical device and the optical fibre being aligned with the spot size converter to provide coupling of light between the optical device and the optical fibre.

11. An optical assembly according to claim 10, in which the optical device is a semiconductor edge emitting waveguide device.

12. An optical bench or optical assembly substantially as shown in and/or described with reference to any of FIGS. 1 to 9 of the accompanying drawings.
